(19) United States
(12) Patent Application Publication
(10) Pub. No.: US 2003/0167886 A1
(43) Pub. Date: Sep. 11, 2003

(54) Adjustable spanner

(76) Inventor: Cheng Liang Lin, Taipei (TW)

Correspondence Address: LIN Cheng Liang, P.O. Box 82-144, Taipei, TW

(21) Appl. No.: 10/093,419

(22) Filed: Mar. 11, 2002

(51) Int. Cl. B25B 13/00

(52) U.S. Cl. 81/186

(57) ABSTRACT

An improved structure of an adjustable spanner, essentially comprised of an adjustable spanner, jaws, rack, screw and coil; within, a thumbscrew is used to adjust the jaws of the spanner; a channel provided in each jaw; a hole drilled in the jaw to accommodate a coil; a T-shape rack being inserted into each channel; a countersunk screw being locked into the rack, and further into the hole to compress the coil; a hole being drilled in the head of the spanner to secure the rack in the jaw with a fixation screw; twisting of the spanner being achieved by having the racks jointly to fly secure the bolt or the nut to compress it with the force from the coil, and in case of limited scope for twisting, the bolt or nut sliding cross counter-clockwise the rack and retreating to allow the spanner to retreat before being twisted clockwise.

### BACKGROUND OF THE INVENTION

(a) Field of the Invention

The present invention is related to an improved structure of an adjustable spanner, and more particularly to a hand tool that is incorporated with the advantage of a socket wrench usually used to tighten up a bolt and a nut.

(b) Description of the Prior Art

Generally, the conventional adjustable spanner is adaptable to various sizes of bolts and nuts; however, it permits only twisting in one direction and a limited scope of twisting with its handle as the pivot, making twisting the spanner harder and longer time consumption.

### SUMMARY OF THE INVENTION

The primary purpose of the present invention is to provide an improved structure of an adjustable spanner that incorporates with the advantages offered by a socket wrench. To achieve the purpose, the outer tooth pattern of the socket is made by matching that from the rack of the jaws for the jaws to firmly clamp the socket while securing a bolt or a nut. Meanwhile, rotation counter-clockwise is executed by means of the compression from the coil before twisting to tighten up clockwise without disengaging from the jaws.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention;

FIG. 2A is a schematic view showing the operation of the present invention;

FIG. 2B is a another schematic view showing the operation of the present invention; and

FIG. 3 is a perspective view showing the present invention as assembled.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

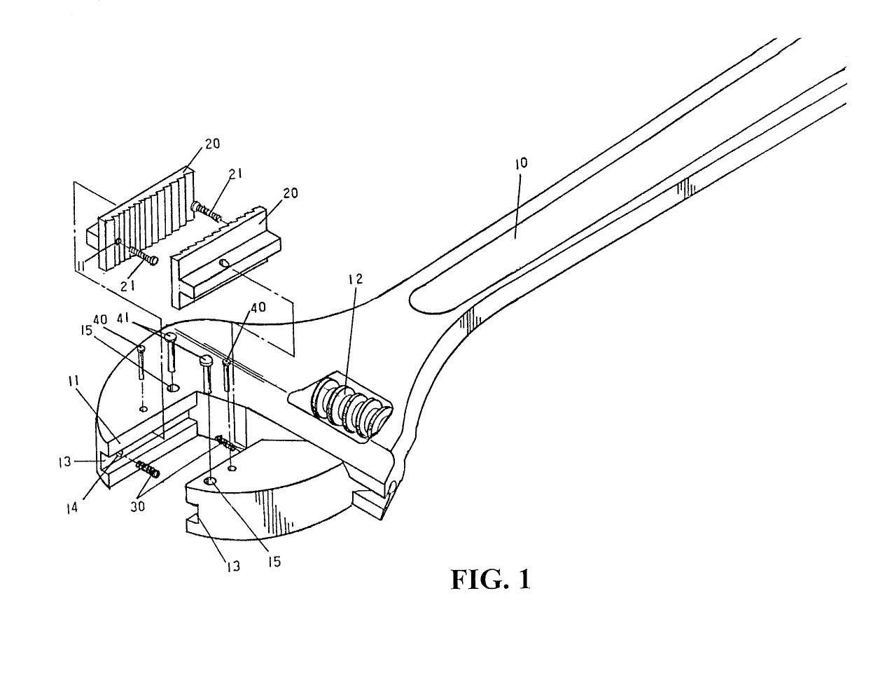

Referring to FIG. 1, an improved structure of an adjustable spanner of the present invention is essentially comprised of an adjustable spanner, rack, thumbscrew, and coil. Within, a thumbscrew (12) is provided for the jaws (11) of the adjustable spanner (10) to adjust the opening or closing of the jaws (11). A channel (13) is each provided in both jaws (11) to receive insertion by the T-shape rack (20). A coil (30) is each buried in a hole (14) drilled at where appropriately inside each jaw (11) and both screws (21) locked into the rack (20) with countersunk screws (40) are also inserted into the holes (14) in the jaws (11) to compress the coils (30). A hole (15) is respectively drilled in the jaws (11) at the head of the spanner (10) to secure the rack (20) with a fixation screws (41).

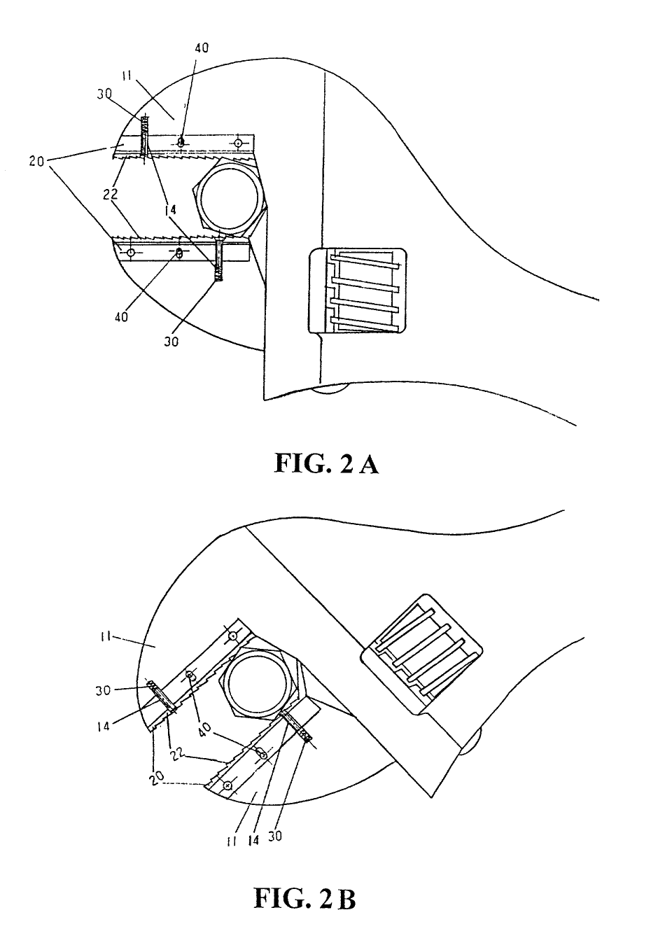

As illustrated in FIGS. 2A and 2B, the rack (20) fixed to the jaws (11) locked up with two countersunk screws (40) while said countersunk screws (40) are also inserted into the holes (14) in the jaws (11) to compress the coil (30). By the spring force provided by the coils (30), the rack (20) becomes retractable. The serrated surface (22) on the rack (20) comprises at a certain inclination the angle of a hexagonal bolt or nut thus to tighten up the bolt or nut by twisting. In case of limited scope for twisting is limited, the bolt or the nut slides in opposite direction to retreat from the compressed rack (20) due to the oblique design of the serrated surface (22) of the rack (20), thus to allow the adjustable spanner to retreat in opposite direction before executing further twisting clockwise.

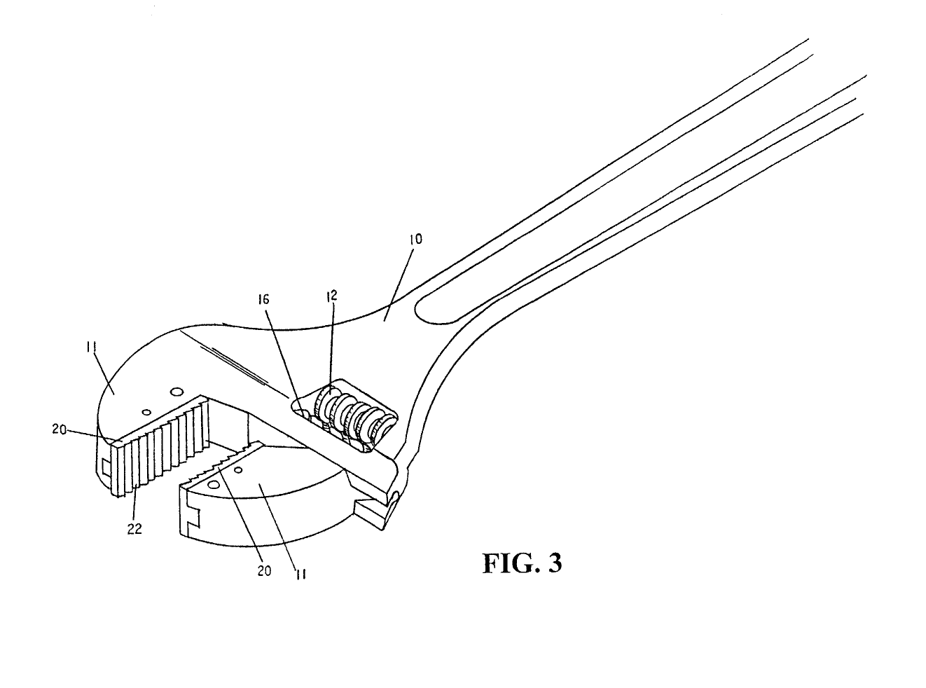

Now referring to FIG. 3, the jaws (11) of the adjustable spanner (10) are regulated by tuning the thumbscrew. The opening of the jaws is controlled by engaging the thumbscrew (12) and another rack (16) to adapt to bolt or nut of different size. In the present invention as disclosed, the optimal function of the adjustable spanner (10) is achieved by the serrated surface (22) askew provided on the rack (20) to secure the bolt or the nut and rotate it counter-clockwise and to twist it clockwise.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of an adjustable spanner, essentially comprised of an adjustable spanner, jaws, rack, screw and coil, characterized by that one channel being provided to each jaw; a coil buried in a hole drilled in each jaw; each channel being inserted with a T-shape rack; a countersunk used to lock up the rack being also inserted into the hole to compress the coil; another hole being drilled in the head of the spanner to secure the rack of the jaw with a fixation screw; the rack in the jaw being retractable due to the coil; a bolt or a nut sliding through the rack in the jaw in opposite direction to retreat; and the adjustable spanner retreating counter-clockwise before being twisted clockwise.
